(19) United States
(12) Patent Application Publication
(10) Pub. No.: US 2021/0190565 A1
(43) Pub. Date: Jun. 24, 2021

(54) Rotary Flow Meter For Measuring Gas Flow

(71) Applicant: COMMON SPOLKA AKCYJNA, Lodz (PL)

(72) Inventors: Przemyslaw JANECZEK, Lodz (PL); Jerzy KWILMAN, Lodz (PL); Pawel SIEROCINSKI, Lodz (PL); Konrad SKIBA, Lodz (PL); Jaroslaw STASIAK, Lodz (PL)

(21) Appl. No.: 17/263,331

(22) PCT Filed: Sep. 11, 2019
(86) PCT No.: PCT/EP2019/074275

§ 371 Date: Jan. 26, 2021

(30) Foreign Application Priority Data
Sep. 11, 2018 (EP) 18193611.3

(51) Int. Cl. G01F 3/10

(52) U.S. Cl. CPC G01F 3/10

(57) ABSTRACT

A rotary gas flow meter comprising a pair of three-toothed rotors, each of which has the shape of a double helical gear, wherein the first rotor is a mirror reflection of the second rotor, and the rotors are adapted to rotate in opposite directions; moreover, the flow meter comprises a body sealing the rotors forming measurement chambers, formed between the outer surfaces of the rotors and the inner surface of the body. The rotary gas flow meter further comprises the measurement chambers have strictly defined volume, and a geometry of rotors is adapted to provide an internal balance of axial forces. The rotors are adapted not to contact each other, and the rotors are synchronised via an external module synchronising the rotation of the rotors.

### BACKGROUND

The present invention relates to a rotary flow meter for measuring gas flow.

The invention represents the field of measuring instruments that register the volume of flowing gas.

Rotary flow meters are characterised by pulsed gas flow. Pulsation is transferred in the form of vibrations to other elements of the unit and may interfere with their operation. There are two main reasons why pulsation is generated. The first is related to the closing and opening of measurement chambers, whereby gas with a higher pressure at the inlet to the inside of the body of the flow meter is transported towards the lower pressure at the outlet from the inside of the body of the flow meter and a pressure surge occurs at the outlet side. The second type of pulsation is produced by uneven increment of volume and pressure in the spaces between the teeth of the rotors, depending on the angle of their rotation. The nature of volume changes depends for example on the shape and profile of the rotors used.

Document U.S. Pat. No. 4,329,130A discloses a rotary flow meter in which three-toothed rotors have a single curved profile, wherein both rotors have the same profile, the same size and the same twist ratio. In the solution disclosed in the American application, the profiles of the rotors are contacted during rotation, and the phenomenon of pulsation is slightly limited by reducing the mutual pressure of the rotor surfaces and the energy transfer between the rotors.

Document U.S. Pat. No. 5,415,041A discloses a device for flow measurement, with two dual helically curved rotors. The four-toothed rotors described in the American patent application rotate in mutual contact, thereby providing a high contact factor. The solution allows for limiting the generation of axial, lateral and distal loads between the rotors and as a result of changes of pressure in the measurement device.

### SUMMARY

The object of the invention is to overcome the drawbacks of the prior art solutions and to completely eliminate pulsation in the flow meter due to uneven increment of volume between the teeth of the rotors.

The essence of the solution is a rotary gas flow meter comprising a pair of three-toothed rotors, each of which has the shape of a double helical gear, wherein the first rotor is a mirror reflection of the second rotor, and the rotors are adapted to rotate in opposite directions; moreover, the flow meter comprises a body sealing the rotors forming measurement chambers, formed between the outer surfaces of the rotors and the inner surface of the body. The rotary gas flow meter further comprises the measurement chambers have strictly defined volume, and a geometry of rotors is adapted to provide an internal balance of axial forces. The rotary gas flow meter is characterized in that the rotors are adapted not to contact each other, and the rotors are synchronised via an external module synchronising the rotation of the rotors.

Preferably, the teeth of the rotors in the shape of a double helical gear have one extremity of a tooth along the height of the rotor and the meeting location of the two helices of the same tooth along the height of the rotor angularly displaced along the height of the rotor by an angle α

$$α = \frac{360 °}{2 z}$$

where z is the number of teeth of the rotor.

Preferably, the rotors in the shape of a double helical gear are three-toothed and interact with the inner surface of the body over a section with an angular length expressed by the wrap angle (3

$$β = \frac{540 °}{z}$$

where ‘z’ is the number of teeth of the rotor.

Preferably, the adjacent teeth of the three-toothed rotors in the shape of a double helical gear have their tops displaced from each other by an angle Y of 120°.

Preferably, the displacement angle α of the tops of the tooth of the rotor along the height of the rotor corresponds to half the displacement angle Y of the tops of adjacent teeth of the rotor with respect to each other.

Preferably, the rotors and the body of the flow meter are made of plastic in 3D printing technology.

Preferably, the rotors and the body of the flow meter are made of an electrically conductive plastic.

The solution of the invention is advantageous because of the complete elimination of pulsation resulting from uneven increments of volume and pressure between the teeth of the rotors achieved through the use of an external synchronising module that prevents the rotors from contacting each other. Additionally, the use of three-toothed rotors in the shape of a double helical gear with a specific displacement angle of the rotors' tops with respect to each other and a specific wrap angle, an internal balance of axial forces between the rotors has been achieved.

### BRIEF DESCRIPTION OF THE DRAWINGS

The subject matter of the invention is presented in greater detail in a preferred embodiment in the drawing, in which:

FIG. 1 is a schematic view of the rotary flow meter in a top view;

FIG. 2 is a view of two rotors coupled with an external synchronising module, in an isometric view;

FIG. 3 is a detailed view of the rotor of the rotary flow meter;

### DETAILED DESCRIPTION

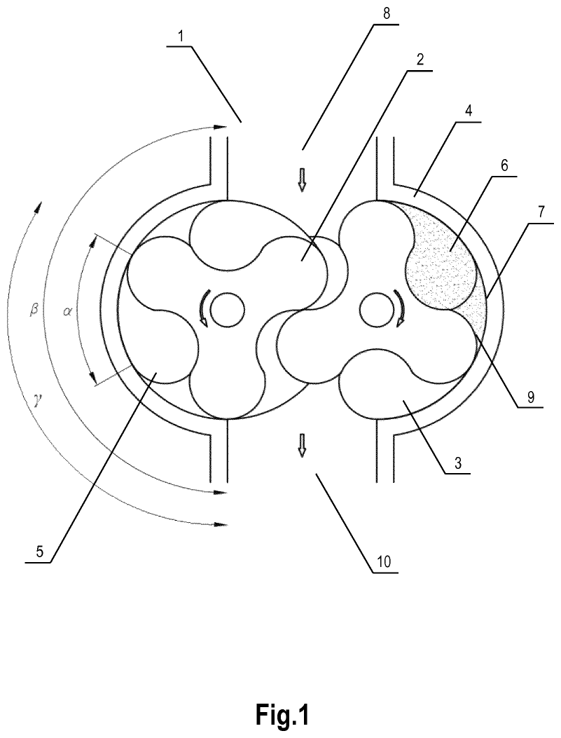

In FIG. 1 is a schematic view of the rotary flow meter 1 in an embodiment, in a top view. The rotary flow meter 1 has a pair of three-toothed rotors 2, 3, adapted by an external synchronising module 11 (not shown in FIG. 1) to rotate in opposite directions. The rotors 2, 3 are arranged in the body 4 sealing the rotors 2, 3 adapted to form temporary measurement chambers 5, 6 such that the inner surface of the body 7 cooperates with the individual rotors 2, 3 over a section having an angular length expressed by the wrap angle (β). The wrap angle (β) depends directly on the number of teeth of the rotor (z) and can be calculated from the following formula:

$$β = \frac{540 °}{z}$$

According to this embodiment of the rotary flow meter 1 with three-toothed rotors 2, 3, the wrap angle (β) is 189®, and the adjacent teeth of the three-toothed rotors 2, 3 in the shape of a double helical gear have their tops displaced from each other by an angle (Y) of 120°. The advantage achieved by using the strictly defined geometry of the rotors 2, 3 is the balance of the internal axial forces that interact between them. Moreover, according to this embodiment of the invention, body 4 is adapted to form temporary measurement chambers 5, 6 having a strictly defined volume, such that gas flowing to the inside of the body 4 through the inlet 8 fills the measurement chambers 5, 6 formed between the external surfaces of the rotors 9 and the internal surface of the body 7, and the overpressure at the inlet 8 of the gas causes the rotors 2, 3 to rotate and a portion of gas to be transported to the outlet from the inside of the body 4. The rotors (2, 3) and the body (4) of the flow meter can be made of plastic in 3D printing technology, and preferably, in particular of an electrically conductive plastic. The advantage achieved by using the 3D printing technology when making the flow meters is the ability to precisely and accurately reproduce the shape of the rotors. The use of an electrically conductive plastic is important as it regards safety and it allows for discharging the electrostatic charge accumulating in the flowing gas.

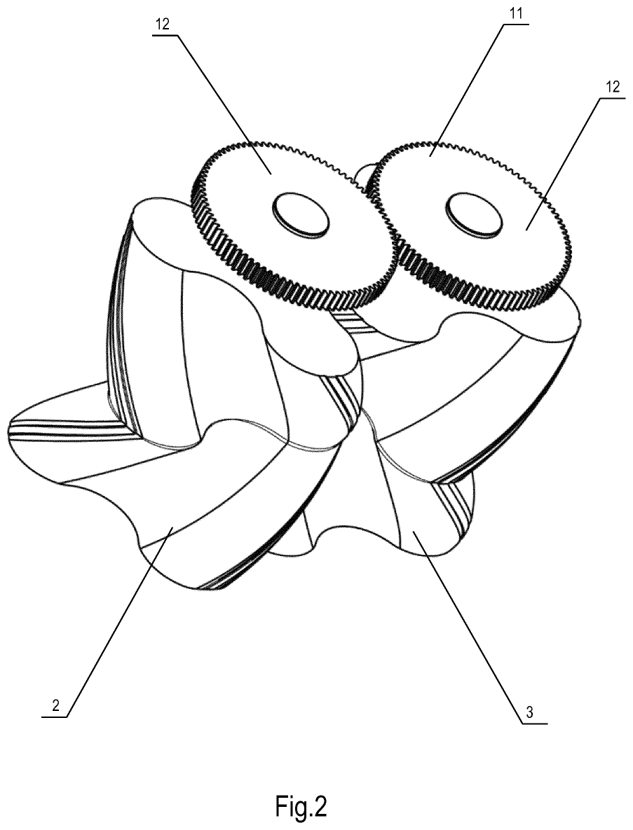

FIG. 2 is a view of two rotors 2, 3 in the shape of a double helical gear coupled with an external synchronising module 11 in an isometric view. According to this embodiment of the invention, the first rotor 2 is a mirror reflection of the second rotor 3, and, in addition, the rotors 2, 3 are adapted by an external synchronising module 11 to rotate in the opposite direction, without contacting each other, and, preferably, the second rotor 3 is adapted to rotate clockwise, and the first rotor 2 is adapted to rotate counter-clockwise. Moreover, the synchronising module 11 synchronises the rotations of the rotors 2, 3 so that the surfaces of the rotors 2, 3 do not contact each other. As shown in FIG. 2 the synchronising module preferably has the form of a gear transmission with two interlocking toothed wheels 12.

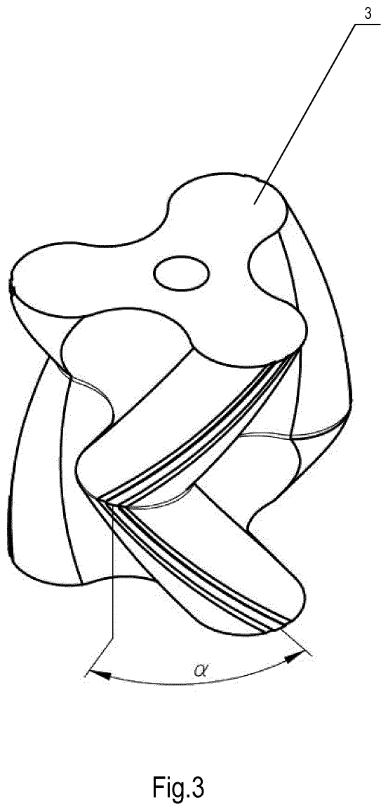

FIG. 3 is a detailed view of the rotor 3 of the rotary flow meter 1. An advantageous technical result of balancing the axial forces between the rotors 2, 3 has been achieved by using an appropriate profile and shape thereof, in particular by selecting an appropriate displacement angle (α) of the tops of the individual teeth of the rotors 2, 3. The top of an individual tooth refers to an extremity or end of the tooth with respect to the height of the rotor. The top of the tooth is angularly displaced from the meeting location of the two helices of the same tooth along the height of the rotor. So the shape of a double helical gear has one extremity (top) of a tooth of the rotor along its height and the meeting location of the two helices of the same tooth along the height of the rotor angularly displaced from each other. Thus, each rotor tooth has two helices which extend along the height of its respective rotor and meet together at the meeting location along the height of the rotor, and the end or extremity of the tooth along the height of the rotor is angularly displaced from the meeting location by an angle (α).

In particular, the advantageous result of balancing the axial forces is achieved when the displacement angle (α) of the tops of the tooth of the rotor 3 in relation to the height of the rotor 3 corresponds to half the angle (Y) between adjacent tops of the rotor 3. Moreover, angle (α) depends directly on the number of teeth of the rotor (z) and can be calculated based on the following ratio

$$α = \frac{360 °}{2 z}$$

According to this embodiment of the three-toothed rotor, angle (α) has 600.

1-7. (canceled)

8. A rotary gas flow meter comprising:
a pair of rotors, each rotor having the shape of a double helical gear with at least three teeth, wherein the first rotor is a mirror reflection of the second rotor, and the rotors are adapted to rotate in opposite directions; and
a body sealing the rotors forming measurement chambers between outer surfaces of the rotors and an inner surface of the body, wherein the measurement chambers have strictly defined volume;
wherein a geometry of the rotors is adapted to provide an internal balance of axial forces,
the rotors are adapted not to contact each other, and
the rotors are synchronised via an external module synchronising rotation of the rotors.

9. The flow meter of claim 8, wherein each tooth of the rotors has two helices which extend along a height of its respective rotor and meet together at a meeting location along the height of the rotor, and an end of the tooth along the height of the rotor is angularly displaced from the meeting location along the height of the rotor by an angle (α):
$$α = \frac{360 °}{2 z}$$
where z is the number of teeth of the rotor.

10. The flow meter of claim 9, wherein the rotors are three-toothed rotors and the angle (α) is 60°.

11. The flow meter of claim 9, wherein each rotor interacts with the inner surface of the body over a section with an angular length expressed by a wrap angle (β):
$$β = \frac{540 °}{z}$$
where z is the number of teeth of the rotor.

12. The flow meter of claim 11, wherein the rotors are three-toothed rotors, the angle (α) is 60°, and the wrap angle (β) is 180°.

13. The flow meter of claim 11, wherein the ends of adjacent teeth of each rotor are angularly displaced from each other by an angle (Y).

14. The flow meter of claim 13, wherein the angle (α) corresponds to half the angle (Y).

15. The flow meter of claim 14, wherein the rotors are three-toothed rotors, the angle (α) is 60°, the wrap angle (β) is 180°, and the angle (Y) is 120°.

16. The flow meter of claim 9, wherein the ends of adjacent teeth of each rotor are angularly displaced from each other by an angle (Y).

17. The flow meter of claim 16, wherein the angle (α) corresponds to half the angle (Y).

18. The flow meter of claim 17, wherein the rotors are three-toothed rotors, the angle (α) is 60°, and the angle (Y) is 120°.

19. The flow meter of claim 8, wherein each rotor interacts with the inner surface of the body over a section with an angular length expressed by a wrap angle (β):
$$β = \frac{540 °}{z}$$
where z is the number of teeth of the rotor.

20. The flow meter of claim 19, wherein the rotors are three-toothed rotors and the wrap angle (β) is 180°.

21. The flow meter of claim 19, wherein ends of adjacent teeth of each rotor are angularly displaced from each other by an angle (Y).

22. The flow meter of claim 21, wherein the rotors are three-toothed rotors, the wrap angle (β) is 180°, and the angle (Y) is 120°.

23. The flow meter of claim 8, wherein the rotors are three-toothed rotors, and ends of adjacent teeth of each three-toothed rotor are angularly displaced from each other by an angle (Y) of 120°.

24. The flow meter of claim 23, wherein each tooth of the rotors has two helices which extend along a height of its respective rotor and meet together at a meeting location along the height of the rotor, and an end of the tooth along the height of the rotor is angularly displaced from the meeting location along the height of the rotor by an angle (α).

25. The flow meter of claim 24, wherein the angle (α) corresponds to half the angle (Y).

26. The flow meter of claim 8, wherein the rotors and the body of the flow meter are made of 3D-printed plastic.

27. The flow meter of claim 8, wherein the rotors and the body of the flow meter are made of electrically conductive plastic.
